(19) United States
(12) Patent Application Publication
(10) Pub. No.: US 2026/0253205 A1
(43) Pub. Date: Aug. 27, 2026

(54) METHOD FOR PREDICTING ROOT CAUSE OF DEFECTS IN ASSEMBLY UNITS

(71) Applicant: Instrumental, Inc., Los Altos, CA (US)

(72) Inventor: Samuel Bruce Weiss, Los Altos, CA (US)

(21) Appl. No.: 19/552,740

(22) Filed: Feb. 27, 2026

Related U.S. Application Data
(60) Provisional application No. 63/764,213, filed on Feb. 27, 2025.

(51) Int. Cl. G06T 7/00; G06T 7/12; G06V 10/44; G06V 10/764

(52) U.S. Cl. CPC G06T 7/001; G06T 7/12; G06V 10/457; G06V 10/764; G06T 2207/30164; G06T 2207/30242; G06V 2201/06

(57) ABSTRACT

One variation of a method includes: accessing a defect log associated with an assembly unit; deriving a location of a defect on the assembly unit based on the defect log; isolating a set of visual features spatially proximal the defect; isolating a set of nonvisual features associated with the defect; accessing an assembly graph defining a set of assembly processes for manufacturing of the assembly unit and corresponding defects; generating a correlation matrix, based on the assembly graph, specifying a set of correlations between the set of visual features and the defect, and the set of nonvisual features and the defect; isolating a subset of features, in the set of visual features and the set of nonvisual features, exhibiting correlations, in the set of correlations, exceeding a threshold correlation; and generating a prediction of a root cause of the defect, the root cause specifying the first subset of features.

### CROSS-REFERENCE TO RELATED APPLICATIONS

This application claims the benefit of U.S. Provisional Application No. 63/764,213, filed on 27 Feb. 2025, which is incorporated in its entirety by this reference.

This application is related to U.S. Non-Provisional application Ser. No. 16/506,905, filed on 9 Jul. 2019, which is hereby incorporated in its entirety by this reference.

### TECHNICAL FIELD

This invention relates generally to the field of manufacturing and assembly processes and, more specifically, to a new and useful method for predicting root cause of defects in assembly units in the field of manufacturing and assembly processes.

### BRIEF DESCRIPTION OF THE FIGURES

FIG. 1 is a flowchart representation of a method;

FIG. 2 is a flowchart representation of one variation of the method;

FIGS. 3A and 3B are flowchart representations of one variation of the method;

FIG. 4 is a flowchart representation of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

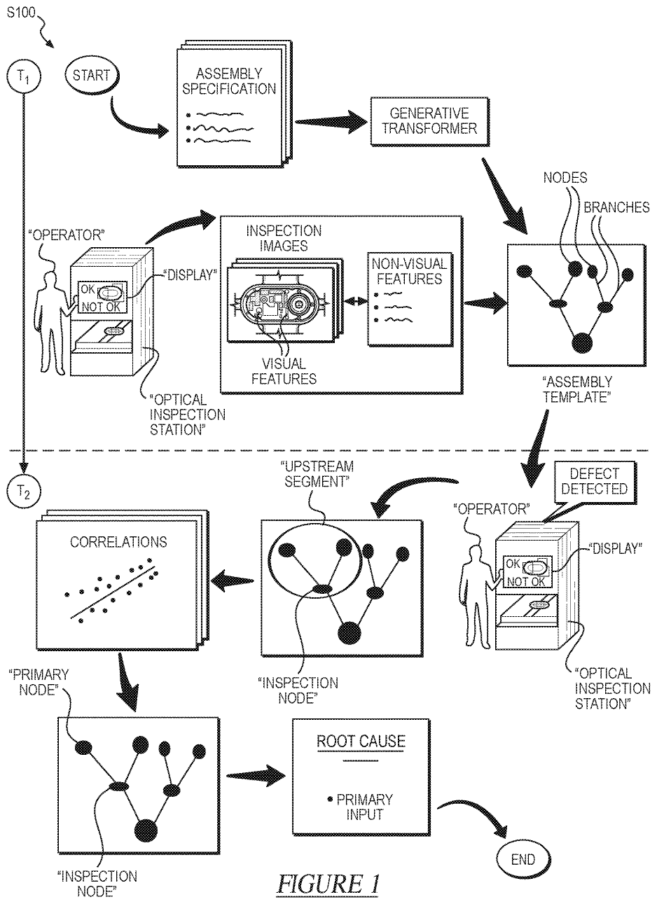

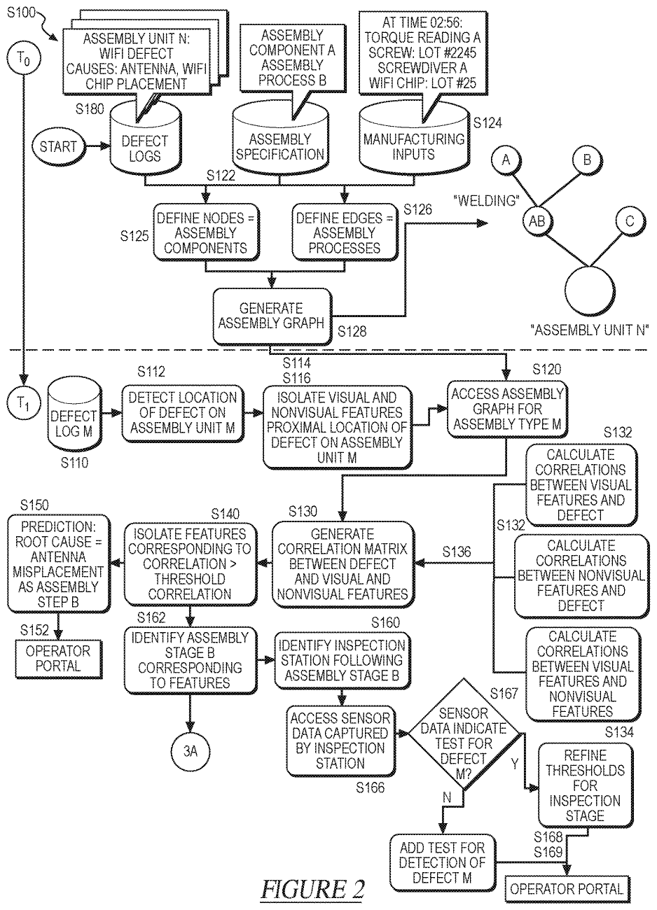

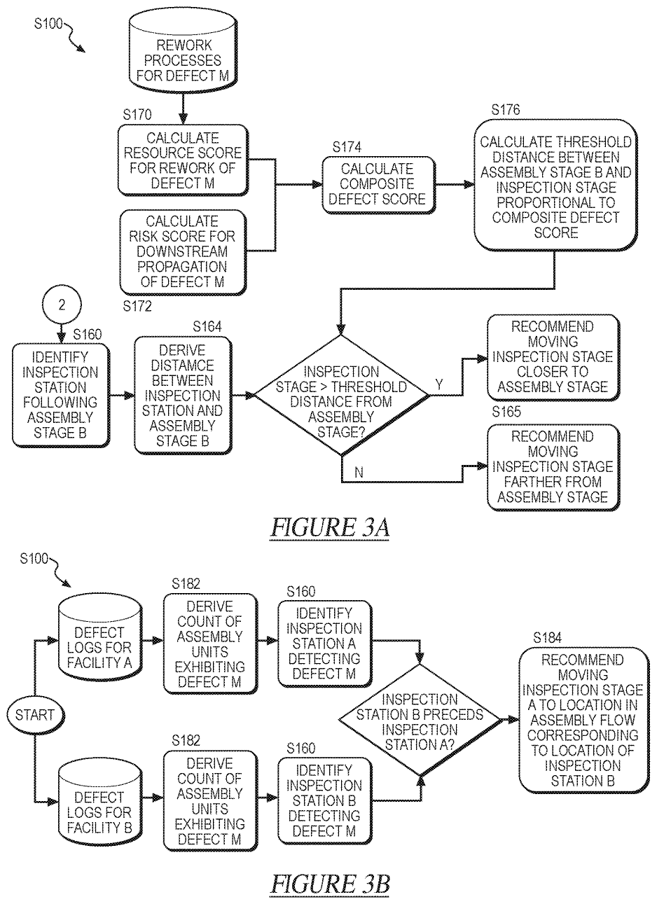

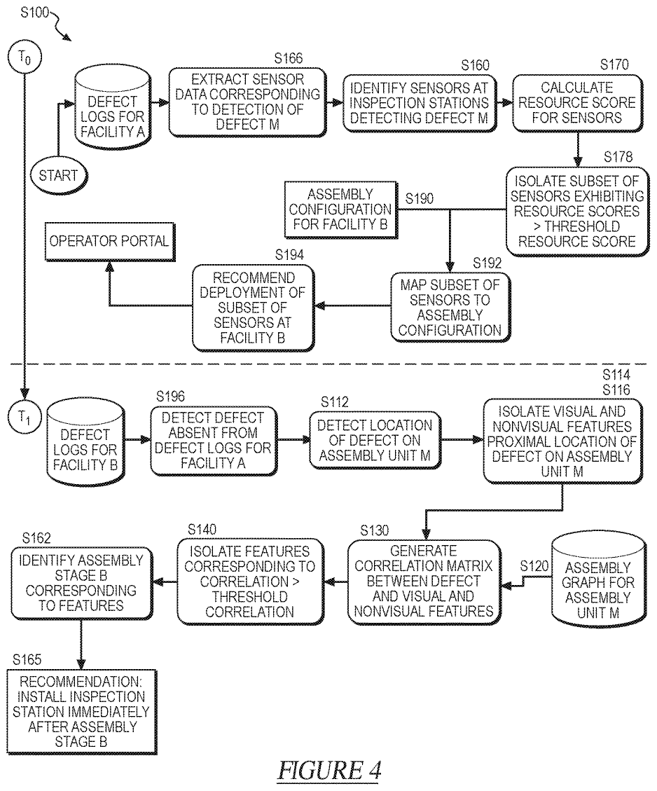

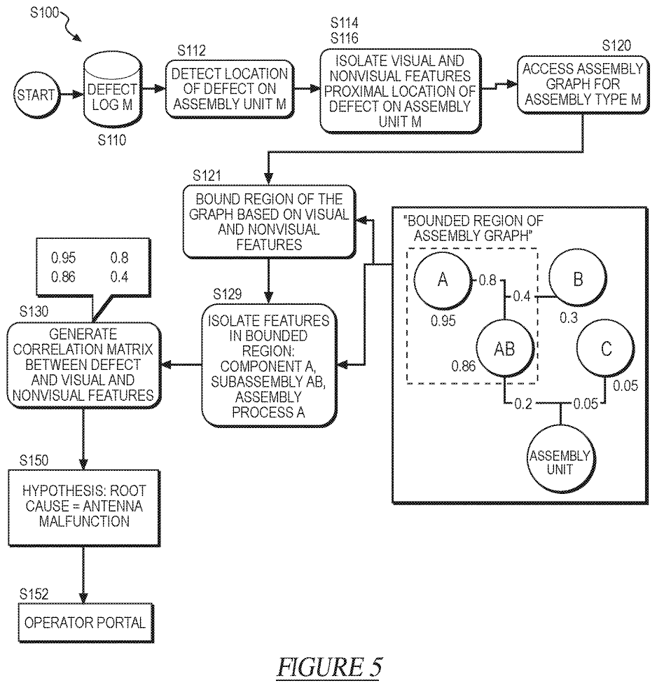

As shown in FIGS. 1-5, a method S100 includes, for a first assembly unit in a set of assembly units: accessing a defect log associated with the first assembly unit in Block S110; deriving a location of a defect on the first assembly unit based on the defect log in Block S112; isolating a first set of visual features spatially proximal the location of the defect on the first assembly unit in Block S114; and isolating a second set of nonvisual features associated with the defect according to the defect log in Block S116.

The method S100 also includes accessing an assembly graph associated with the set of assembly units in Block S120, the assembly graph defining: a first set of nodes representing assembly components and subassemblies associated with manufacturing of the set of assembly units, the first set of nodes labeled with corresponding defects; and a set of edges, connecting nodes in the set of nodes and representing a set of assembly processes for manufacturing of the set of assembly units, the set of edges labeled with corresponding defects.

The method S100 further includes: defining a bounded region of the assembly graph, including a first subset of nodes and a first subset of edges, based on the first set of visual features and the second set of nonvisual features in Block S121; isolating a first set of features defined in the bounded region of the assembly graph in Block S129; based on the assembly graph and for each feature in the first set of features, generating a correlation, in a set of correlations, between the feature and the defect in Block S132; assembling the set of correlations into a correlation matrix in Block S136; isolating a first subset of features, in the first set of visual features and the second set of nonvisual features, exhibiting correlations, in the set of correlations, exceeding a threshold correlation in Block S140; generating a prediction of a root cause of the defect, the root cause specifying the first subset of features in Block S150; and serving the prediction of the root cause of the defect to an operator portal in Block S152.

### 1.1 Variation: Zero-Shot Root Cause Prediction

In one variation, the method S100 includes: accessing a defect log associated with a first assembly unit in a first set of assembly units in Block S110; deriving a location of a defect on the first assembly unit based on the defect log in Block S112; isolating a first set of visual features spatially proximal the location of the defect on the first assembly unit in Block S114; isolating a second set of nonvisual features associated with the defect according to the defect log in Block S116; for each visual feature in the first set of visual features, calculating a first correlation, in a first set of correlations, between the visual feature and the defect in Block S132; and, for each non-visual feature in the second set of non-visual features, calculating a second correlation, in a second set of correlations, between the non-visual feature and the defect in Block S134.

This variation of the method S100 also includes: assembling the first set of correlations and the second set of correlations into a correlation matrix in Block S136; isolating a first subset of features, in the first set of visual features and the second set of nonvisual features, exhibiting correlations, in the correlation matrix, exceeding a threshold correlation in Block S140; generating a prediction of a root cause of the defect, the root cause specifying the first subset of features in Block S150; and serving the prediction of the root cause of the defect to an operator portal in Block S152.

### 1.2 Variation: Interfacility Transfer of Knowledge

In another variation, the method S100 includes: accessing a corpus of defect logs associated with a first set of assembly units manufactured at a first manufacturing facility and specifying a first corpus of defects associated with the first set of assembly units in Block S110; extracting a corpus of sensor data, captured by sensors at a set of inspection stations during manufacture of the first set of assembly units, from the corpus of defect logs in Block S166; isolating a set of sensors associated with detection of the first corpus of defects based on the corpus of sensor data in Block S160; for each sensor in the set of sensors, calculating a resource score proportional to a count of defects detected by the sensor in Block S170; and isolating a subset of sensors in the set of sensors, the subset of sensors exhibiting resource scores exceeding a threshold resource score in Block S178.

This variation of the method S100 also includes: accessing an assembly configuration associated with a second manufacturing facility distinct from the first manufacturing facility in Block S190; mapping the subset of sensors to corresponding inspection stages at the second manufacturing facility based on the assembly configuration in Block S192; and recommending installation of the subset of sensors, at corresponding inspection stages, at the second manufacturing facility in Block S194.

### 2. Applications

Generally, a computer system-cooperating with assembly equipment, inspection and test equipment, and/or a database aggregating visual and nonvisual manufacturing data across an assembly line (hereinafter “the computer system”)—can execute a method to: define an assembly graph representing a hierarchical network of nodes and branches corresponding to assembly stages (e.g., soldering, torque application, component placement) and dependencies (e.g., material flow, tool calibration, process timing) in an assembly process; isolate a subset of visual and nonvisual features recorded for the assembly unit and associated with a defect detected in an assembly unit; map the subset of visual and nonvisual features to a bounded subset of assembly components and assembly processes associated with the defects based on this assembly graph; compute correlations (e.g., first-order and/or higher-order correlations) between these features and the defects; and output a prediction of a root cause of a defect based on a subset of these features exhibiting highest correlations to the defect.

In particular, the computer system can execute Blocks of the method to identify where the assembly line should collect data and what the assembly line should test for in order to detect (or preempt) defects sooner. For example, when an assembly unit fails a functional test indicating a defect (e.g., a Wi-Fi subsystem fails, an antenna is nonfunctional, a battery does not charge, a gearbox grinds), the computer system can: reference an assembly graph defining relationships between assembly components (as nodes) and assembly processes (as edges); identify a region of the assembly graph that bounds when relevant components first enter the assembly and when these components become encased, inaccessible, or otherwise no longer influenced by downstream assembly stages; and then isolate the subset of features recorded within this region (e.g., component identifiers, batch identifiers, torque values, alignment measurements, temperature profiles, operator actions, toolpaths, inspection images, and functional test logs) as the candidate feature set that could have produced the defect.

In one example, the computer system detects a defect associated with antenna performance of a router at a final functional test stage. In this example, the computer system can identify—in the assembly graph—an antenna-installation branch and can bound analysis to assembly stages spanning a first installation of the antenna through an encapsulation stage, after which downstream assembly processes may not physically reposition the antenna component. The computer system can then: isolate the subset of features recorded within this bounded region (e.g., a fastener torque at an antenna-install stage, an alignment image at a cable-routing stage, a solder temperature profile at a PCB processing stage, a firmware identifier at a flashing stage); and compute correlations between these features and the defect in order to distinguish co-occurring anomalies from likely causal anomalies (e.g., anomaly A causes anomaly B causes anomaly C and then the defect; anomaly A combined with anomaly B causes the defect and anomaly C is irrelevant).

Therefore, rather than solely relying on surface-level correlations between defects and manufacturing inputs to predict causes for defects in assembly units, the computer system can leverage hierarchical assembly process—as well as causal relationships between stages of this assembly process—for identifying significant contributors to defects, such as causal relationships defined in a hierarchical assembly network to predict a first-order root cause (e.g., node A causes a defect) or a second-order root cause (e.g., node B causes node A, which causes a defect; node C causes nodes A and B, which—in combination—causes a defect), such as visual (e.g., images of misaligned components or scratches) and/or non-visual (e.g., torque values or temperature readings) manufacturing inputs captured by sensors or extracted from logs at the assembly line, for defects detected at specific assembly stages.

Thus, by executing a targeted traversal of the assembly graph to bound correlation matrix generation to defect relevant nodes and edges of the assembly graph, the computer system can: identify features exhibiting high correlation to the defect in order to increase confidence in prediction of a root cause; reduce computational resources otherwise consumed by entire assembly graph analysis; and increase overall throughput and yield of a manufacturing facility while reducing computational resource consumption.

### 2.1 Root Cause Prediction

In one implementation, the computer system can: receive inspection results (e.g., inspection images from an optical inspection station, test results, manual quality checks) indicating a defect (e.g., a misaligned component, insufficient solder joint, or surface crack) in an assembly unit at a specific stage at the assembly line; identify an upstream segment (e.g., a subset of nodes and branches) in the assembly graph that includes steps and dependencies (e.g., sequential operations, material flows) converging toward the assembly stage associated with the defect; and analyze each node in the upstream segment to calculate correlations (e.g., statistical relationships) between the defect and manufacturing inputs (e.g., torque values, reflow oven temperature profiles, or material properties) populated in the node. The system can then: identify a primary node in the upstream segment exhibiting a correlation exceeding a threshold (e.g., correlation coefficient greater than 0.8) between the defect and manufacturing inputs contained in the primary node; trace branches in the upstream segment to isolate a shared manufacturing input (e.g., solder paste viscosity variations, tool calibration errors) or a specific input at the primary node (e.g., a torque value or temperature setting) linked to the defect; and predict this manufacturing input as a root cause, such as a first-order root cause (e.g., node A causes defect) or a second-order root cause (e.g., node B causes node A which causes defect; node C causes nodes B and A, which cause defect), of the defect.

In one example, the computer system can: receive inspection results indicating a solder bridging defect in a printed circuit board assembly process at the reflow soldering stage; identify an upstream segment in the assembly graph, including nodes representing the solder paste deposition, component placement, and reflow soldering stages, and including branches capturing dependencies (e.g., material flow of solder paste, sequential timing of component placement and soldering); and analyze each node in the upstream segment to calculate correlations (e.g., correlation coefficients) between the solder bridging defect and manufacturing inputs, such as solder paste volume at the solder paste deposition stage, alignment accuracy at the component placement stage, and reflow oven temperature profiles at the reflow soldering stage.

The system can then: identify the reflow soldering stage as a primary node, exhibiting a correlation exceeding a threshold (e.g., a correlation coefficient of 0.9) between the solder bridging defect and the reflow oven temperature profile; trace branches in the upstream segment to confirm that the reflow oven temperature profile at the primary node directly influences (e.g., primary node causes defect) the defect by overheating the solder paste, resulting in excessive flow and bridging between adjacent components; and predict the reflow oven temperature profile as a first-order root cause (e.g., node A causes defect) of the solder-bridging defect in the printed circuit board assembly.

Therefore, the computer system can predict a primary manufacturing input (e.g., reflow oven temperature profile or torque value) as a root cause-such as a first-order root cause or a second-order root cause—of a defect, thereby reducing the need for manual tracing of defects across multiple assembly stages to expediently identify and resolve this root cause for subsequent instances of the assembly unit, of a particular unit type, at the assembly line.

### 2.1.1 Resolving Root Cause

The computer system can then, based on the identified root cause, implement corrective actions to resolve root causes (e.g., first-order root causes, second-order root causes), such as by setting operational limits on manufacturing inputs to constrain variations contributing to the root cause, generating new inspection tests targeted at detecting the root cause earlier in the assembly process, and modifying the assembly graph to mitigate conditions leading to failures associated with the root cause.

### 2.2 Sensor Locations+Deployment at New Facilities

In one implementation, the computer system can execute Blocks of the method S100 to refine configuration of inspection stages based on predicted root causes of defects. In particular, the computer system can: identify an assembly stage associated with a predicted root cause (e.g., the assembly stage at which a correlated subset of features is first introduced); identify a first inspection stage succeeding this assembly stage; and access sensor data and test logs captured at this inspection stage to identify what features are currently measured, what defects are currently tested for, and what anomaly thresholds are currently enforced. In response to detecting that the inspection stage is not configured to detect defects similar to the defect (or not configured to detect precursor anomalies represented by the correlated subset of features), the computer system can recommend addition of a test and/or deployment of a sensor at this inspection stage. Additionally or alternatively, in response to detecting that the inspection stage already measures a relevant feature, but permits anomalous values correlated with downstream failure, the computer system can recommend tightening a tolerance range (or other anomaly threshold) for this test in order to detect precursor anomalies throughout the assembly line.

Furthermore, the computer system can execute Blocks of the method S100 to: aggregate defect logs, sensor data, and test results across multiple manufacturing facilities to characterize relative value of sensors and tests deployed at these facilities.

Based on this sensor data, the computer system can: calculate composite value or risk scores for sensors and tests; identify redundant sensors and/or tests; and/or identify sensors and tests that consume increased operational resources while contributing low defect-detection value (e.g., sensors that rarely detect minor defects). The computer system can then recommend removal, deprecation, or replacement of such sensors and tests to reduce inspection resource consumption without materially increasing defect escape.

After identifying a set of sensors and tests that provide high-value defect detection for manufacturing of a particular assembly unit type, the computer system can execute Blocks of the method S100 to transfer this sensing and testing knowledge to other manufacturing facilities. For example, the computer system can: access an assembly configuration of a second facility; and map high-value sensors and tests learned from a first facility to corresponding inspection stages of the second facility.

In one variation, the computer system can define an assembly configuration of a second facility (e.g., an existing facility undergoing retrofit); and recommend addition, removal, relocation, and/or reconfiguration of sensors and tests to replicate or improve defect detection performance achieved at the first facility.

In another variation, for the second facility (e.g., a new facility), the computer system can recommend an initial sensor and test deployment plan based on defect detection utility learned at other facilities. Additionally, the computer system can: detect differences between facilities, such as environmental conditions, materials, suppliers, or tooling; and recommend sensors and tests tailored to defect mechanisms likely to arise under differing conditions per manufacturing facility.

Thus, the computer system extends the assembly graph-bounded root cause analysis described herein beyond a single assembly line to a network of manufacturing facilities, thereby enabling manufacturers to reduce time-to-detection of defects, avoid repetition of known failure modes, accelerate commissioning of new manufacturing lines, and improve yield and throughput across distributed manufacturing operations.

The method S100 is described herein as executed by a remote computer system (e.g., a remote server, a computer network). However, Blocks of the method S100 can be executed by one or more local computing devices within or connected to a computer network, by a local computer, or by any other computer system.

### 3. Example: AI Server Manufacturing

In one example, the computer system can implement methods and techniques as described herein for manufacture of an AI server.

In this example, the computer system can: characterize the AI server assembly unit as a rack-mounted server including a chassis, a set of GPUs, a set of CPUs, memory modules, power supplies, and networking components installed and configured during manufacture; and access manufacturing data associated with a sequence of assembly stages including chassis assembly, board installation, cable routing, firmware flashing, and functional testing. Based on this manufacturing data collected during these assembly stages, the computer system can define an assembly graph representing relationships between assembly components and assembly processes for manufacture of the AI server assembly unit. In particular, the computer system can: define nodes in the assembly graph representing assembly components and subassemblies of the AI server assembly unit; and define edges in the assembly graph representing assembly processes that introduce, connect, or modify these assembly components.

During manufacture of a particular AI server assembly unit, the computer system can: access visual and nonvisual manufacturing data captured at intermediate assembly stages, including inspection images captured following board installation and cable routing, torque readings captured during fastener installation, firmware identifiers captured during firmware flashing stages, and functional test logs captured during extended functional testing; and associate visual and nonvisual features with corresponding nodes and edges in the assembly graph defining the AI server assembly process.

At a particular inspection station, succeeding a particular assembly stage, the computer system can: detect a defect in the AI server assembly unit during a functional test indicating intermittent failure of a network interface during extended functional testing; and identify a subset of assembly components and assembly processes associated with the defect based on the assembly graph. In particular, the computer system can: isolate a subset of features-including visual features (e.g., PCB installation location) and non-visual features (e.g., torque outputs during installation of the PCB)—for the AI server assembly unit; and identify a bounded region of the assembly graph corresponding to these features. For example, the computer system can identify a bounded region of the assembly graph corresponding to assembly stages including: introduction of a network interface component associated with the intermittent failure of the network interface during extended functional testing; and/or a subsequent assembly stage after which downstream assembly processes no longer physically connect to, electrically couple with, thermally influence, or configure the network interface component. Then, the computer system can: access the assembly graph; and extract and/or compute correlations between these features and the detected defect in order to distinguish co-occurring anomalies from predicted root cause anomalies. Based on these correlations, the computer system can thus generate a prediction of a root cause of the defect specifying a subset of features associated with the defect.

### 4. Terms

A “defect” is referred to herein as a functional failure, a test failure, or other failure condition identified in a defect log associated with an assembly unit.

An “anomaly” is referred to herein as a deviation of a visual or nonvisual feature from an expected, or nominal, value or value range recorded during manufacturing of an assembly unit. In one example, an anomaly can operationally precede, or contribute to, a defect without defining a defect.

A “correlation” is referred to herein as a statistical association between a feature (e.g., a visual feature, a nonvisual feature, an assembly component, an assembly stage, an assembly process) associated with a node and/or edge in an assembly graph, and a defect. In one example, correlations can be calculated for a set of assembly units and mapped onto an assembly graph. In particular, the computer system can access correlations between features and defects to rank candidate features for root cause prediction.

A “root cause” is referred to herein as a feature, associated with a node or edge in a bounded region of an assembly graph, that exhibits a correlation exceeding a threshold correlation relative to a defect and is selected as a primary contributor to the defect.

### 5. System

As described in U.S. Non-Provisional application Ser. No. 16/506,905, blocks of the method S100 can be executed by a computer system, such as: locally on an optical inspection station configured to record inspection images of assembly units; locally near an assembly line populated with optical inspection stations; within a manufacturing space or manufacturing center occupied by this assembly line; or remotely at a remote server connected to optical inspection stations via a computer network (e.g., the Internet), etc. The computer system can also interface directly with other sensors arranged along or near the assembly line to collect non-visual manufacturing and test data or retrieve these data from a report database associated with the assembly. Furthermore, the computer system can interface with databases containing other non-visual manufacturing data for assembly units produced on this assembly line, such as: test data for batches of components supplied to the assembly line; supplier, manufacturer, and manufacturing data for components supplied to the assembly line; etc.

The computer system can also interface with an operator (e.g., an engineer, an assembly line worker) via an operator portal-such as accessible through a web browser or native application executing on a laptop computer or smartphone—to serve prompts and notifications to the operator and to receive defect labels, anomaly feedback, or other supervision from the operator.

### 6. Data Acquisition

Generally, the computer system can access historical defect data associated with a set of assembly units manufactured at a particular manufacturing facility.

In particular, the computer system can: access a defect log associated with an assembly unit; access and/or extract inspection test results from the defect log; and/or access and/or extract sensor data, captured by inspection stations during manufacture of the assembly unit, from the defect log.

In one implementation, the computer system can access a series of inspection images captured by inspection stations during manufacture of the assembly unit. In one example, the computer system can access a series of inspection images captured by inspection stations during manufacture of a set of assembly units, such as a set of assembly units at a particular manufacturing facility and/or across a population of manufacturing facilities.

In one implementation, the computer system can: access manufacturing inputs; and order these manufacturing inputs according to a temporal distribution of these manufacturing inputs. For example, the computer system can order these manufacturing inputs according to a temporal distribution of the manufacturing inputs based on: timestamps assigned to each inspection image, in a corpus of inspection images, captured after completion of an assembly stage; sequential ordering of sensor readings relative to part installation events; temporally-aligned functional test logs spanning multiple assembly stages; and/or identification of data captured before, during, and after a manufacturing action.

Therefore, the computer system can: aggregate raw data related to manufacturing of an assembly unit, including textual descriptions from assembly manuals, visual data from videos and images, and numerical data from sensor logs; and derive a structured dataset, normalized and annotated with relevant features (e.g., dimensions, material tolerances, or assembly dependencies), for ingestion into an assembly graph. Additionally, the computer system can: access defect logs specifying defects associated with these assembly units; and extract defect metadata (e.g., defect location, defect causes) for a corpus of assembly units manufactured at a particular manufacturing facility and/or across a population of manufacturing facilities.

### 6.1 Assembly Sequence

Generally, the computer system can access an assembly specification specifying: a set of assembly stages defining an assembly process for manufacturing of a particular assembly unit of a particular assembly unit type; and a set of assembly components and/or a set of subassemblies associated with manufacturing of the particular assembly unit of the particular assembly unit type.

In one implementation, the computer system can: access an assembly specification (e.g., CAD models, bills of materials, process flow diagrams, and textual assembly instructions) representing the detailed steps, materials, and dependencies required for manufacturing instances of the assembly units of a particular assembly type; implement preprocessing techniques, such as text parsing to extract procedural descriptions, computer vision to analyze annotated diagrams or CAD models, and feature extraction to identify key attributes (e.g., dimensions, material types, or tolerances) from the specification; and aggregate the extracted procedural descriptions, annotated diagrams, and identified attributes into a structured dataset, organizing the data into formats compatible with ingestion by a computational model (e.g., a large language model or transformer-based architecture trained for hierarchical data generation).

For example, the computer system can: access an electronic assembly manual, such as an electronic text document detailing step-by-step instructions for component placement, fastening sequences, and alignment tolerances for assembling a printed circuit board (PCB); and implement preprocessing techniques (e.g., natural language processing) to extract procedural descriptions, identify annotations for dimensions and tolerances, and structure the extracted data into a normalized format.

In another example, the computer system can: access a video depicting an assembly process for an assembly unit, such as a demonstration video depicting an operator manually assembling the printed circuit board; and implement preprocessing techniques (e.g., computer vision) to detect individual components, extract the sequence of assembly steps, and identify key attributes (e.g., torque values or alignment markers) for the manufacturing process.

In one implementation, the computer system can: access an assembly guide associated with a particular assembly unit type; access a corpus of defect logs associated with a set of assembly units of the particular assembly unit type; and generate correlations between assembly component and assembly processes, specified in the assembly graph, and defects specified in the corpus of defect logs.

For example, the computer system can access an assembly guide defining: a set of assembly components associated with manufacturing of the set of assembly units; and the set of assembly processes for manufacturing of the set of assembly units. The computer system can then access a set of defect logs associated with the set of assembly units and, for each defect identified in the set of defect logs: isolate a subset of features associated with the defect; and associate the defect with the subset of features.

In another implementation, the computer system can generate an assembly graph based on visual and/or non-visual manufacturing inputs. In particular, the computer system can: access a corpus of inspection images, captured by optical sensors installed at a set of inspection stations, of the set of assembly units; derive a set of assembly components associated with manufacturing of the set of assembly units based on the corpus of inspection images; based on timestamps of inspection images in the corpus of inspection images, temporally order the corpus of inspection images to derive an assembly sequence for manufacturing of assembly units in the set of assembly units; and define the set of assembly processes for manufacturing of the set of assembly units based on the assembly sequence and visual differences between pairs of inspection images in the corpus of inspection images.

For example, the computer system can associate inputs (e.g., torque readings, inspection images, firmware identifiers, functional test logs) with assembly stages (e.g., fastener installation stage, cable-routing stage, final assembly validation stage) during assembly of the assembly unit.

Therefore, the computer system can execute Blocks of the method to define a structured representation of an assembly flow for the set of assembly units by associating visual and non-visual manufacturing inputs with corresponding assembly stages, assembly components, and assembly processes.

### 7. Assembly Graph

Generally, the computer system can assemble an assembly graph representing assembly components and assembly processes associated with manufacturing of an assembly unit of a particular assembly unit type. In particular, the computer system can: access electronic documents (e.g., CAD models, assembly manuals), digital media (e.g., videos, annotated images), and textual instructions representing steps of an assembly process (e.g., component alignment, subassembly integration) for manufacturing instances of assembly units of a particular assembly type; and define an assembly graph representing a hierarchical structure for the assembly process, including nodes representing assembly components and edges representing assembly stages (e.g., assembly actions) in the assembly process.

In particular, the computer system can: access an assembly specification specifying the set of assembly processes for the set of assembly units in Block S122; access a log of manufacturing inputs representing non-visual and visual features captured during manufacturing of the instances of the assembly unit of the particular unit type in Block S124; define a set of nodes, each node in the set of nodes representing an assembly component (and/or a subassembly) for the assembly unit and labeled with an association with a historical defect in Block S125; define a set of edges, each edge in the set of edges representing an assembly action in the set of assembly processes and labeled with causal relationships between the set of nodes based on the log of manufacturing inputs in Block S126; and define the assembly graph including the set of nodes and the set of edges in Block S128.

In one implementation, the computer system can define a set of nodes, each node identifying an assembly component added/removed from the assembly unit. In particular, the computer system can: define locations of assembly components, within the assembly unit and in three-dimensional space, such as derived from documented assembly steps and/or inferred stages from data timing, and/or associated with a set of assembly components. In particular, the computer system can: define locations of assembly components within the assembly unit with three-dimensional coordinates or regions within the assembly unit; and/or define individual components (e.g., a fastener, a trace) or a subassembly.

In one implementation, the computer system can define nodes based on a predefined assembly guide specifying assembly components within the assembly unit. In particular, the computer system can: access an assembly guide defining a set of assembly components associated with manufacturing of the set of assembly units; and define a first set of nodes, each node in the first set of nodes identifying an assembly component in the set of assembly components.

In another implementation, the computer system can derive assembly components for manufacturing of the assembly unit based on inspection log data. In particular, the computer system can: access a corpus of inspection images, captured by optical sensors installed at a set of inspection stations, of the set of assembly units; derive a set of assembly components associated with manufacturing of the set of assembly units based on the corpus of inspection images; and define a first set of nodes, each node in the first set of nodes identifying an assembly component in the set of assembly components.

Generally, the computer system can define a set of edges, each edge identifying an assembly process in an assembly sequence for manufacturing of the set of assembly units. In particular, the computer system can define a set of edges, each edge identifying an assembly process-such as relationships between nodes (e.g., assembly steps like welding, addition of a part, removing a support/ancillary structure)—including a single manufacturing action. For example, the computer system can define the set of edges representing ordering and/or dependency between the set of nodes.

In one implementation, the computer system can define edges based on a predefined assembly guide specifying assembly processes. In particular, the computer system can: access an assembly guide defining a set of assembly processes for manufacturing of the set of assembly units; and define a first set of edges, each edge in the first set of edges identifying an assembly process, in the set of assembly processes, and linking assembly components in the set of assembly components. In another implementation, the computer system can derive assembly processes for manufacturing of the assembly unit based on inspection log data. In particular, the computer system can: access a corpus of inspection images, captured by optical sensors installed at a set of inspection stations, of the set of assembly units; based on timestamps of inspection images in the corpus of inspection images, temporally order the corpus of inspection images to derive an assembly sequence for manufacturing of assembly units in the set of assembly units; define the set of assembly processes for manufacturing of the set of assembly units based on the assembly sequence and visual differences between pairs of inspection images in the corpus of inspection images; and define a first set of edges, each edge in the first set of edges identifying an assembly process, in the set of assembly processes, and linking assembly components in the set of assembly components.

For example, the computer system can: access a first inspection image depicting a first assembly component and second assembly component defining a first subassembly; access a second inspection image, captured after the first inspection image, depicting the first subassembly and a third assembly component welded to the first subassembly; and detect a first assembly stage, interposed between the first inspection stage and the second inspection stage, defined by welding the third assembly component to the first subassembly.

In one variation, the computer system can populate an assembly graph template with the set of nodes and the set of edges. In particular, the computer system can: access an assembly graph template; populate a set of nodes, in the assembly graph template, with assembly components for the particular assembly unit type; and populate a set of edges, in the assembly graph template, with assembly processes for the particular assembly unit type.

In one implementation, the computer system can: access a stream of manufacturing inputs, such as visual features representing component alignments, shapes, and surface textures, and non-visual features representing torque values and temperature readings, captured (e.g., at an optical inspection station) during a manufacturing process; and populate nodes-output from the computational model (e.g., a transformer-based model trained on manufacturing workflows and defect data)—with data from this stream of manufacturing inputs, such as component dimensions, inspection images, and sensor outputs, to define a temporal sequence of stages and associated features for instances of assembly units, of a particular assembly type, assembled during the manufacturing process. In this implementation, as described in U.S. Non-Provisional application Ser. No. 16/506,905, following completion of a particular assembly stage, the computer system can: receive an image of an assembly unit at the assembly stage, captured at the optical inspection station; implement computer vision techniques to derive visual features from the image, such as shapes, surface textures, and alignment patterns; access a dataset of non-visual features, such as torque values, temperature readings, and process timings, recorded during the assembly stage; and link these non-visual features to the visual features in a feature map corresponding to the assembly stage for instances of the assembly unit, of the particular assembly type, at the assembly stage.

The computer system can then populate an edge—representative of this assembly process—with data including derived visual features (e.g., shapes, surface textures, alignment patterns) and linked non-visual features (e.g., torque values, temperature readings, and process timings), such as by indexing the visual and non-visual features based on unique stage identifiers, assigning timestamps to synchronize data streams, and storing these indexed features in the node as key-value pairs for subsequent analysis. Accordingly, the computer system can repeat this process for each node, corresponding to instances of assembly units, of the particular assembly type, assembled at the assembly line, to construct a temporal representation of the manufacturing process, capturing data across sequential assembly stages and linking derived visual and non-visual features to specific stages over time.

In one implementation, the computer system can: compile the set of nodes—representing assembly components for a particular assembly unit type—and the set of edges—representing assembly processes (e.g., causal relationships and dependencies between nodes)—into a hierarchical network defining temporal sequences and causal linkages for manufacturing instances of assembly units, of the particular assembly type, at the assembly line.

For example, the computer system can compile an assembly graph representing stages of a printed circuit board (PCB) assembly process, such as including a set of edges representing solder paste application, component placement, solder reflow, optical inspection, and annotated with causal relationships between these stages (such as dependencies between solder paste quality and reflow soldering integrity), into an assembly graph defining the temporal sequences and dependencies for assembling a completed PCB.

### 7.1 Assembly Graph: Correlations+Causal Relationships

In one implementation, the computer system can cooperate with a user to annotate the assembly graph with correlations between assembly components, assembly processes, and defects associated with these assembly components and assembly processes. In particular, the computer system can: generate the assembly graph including the set of nodes and the set of edges; and access a set of defect logs associated with a set of assembly units. The computer system can then, for each defect identified in the set of defect logs: isolate a subset of features (e.g., visual features, non-visual features) associated with the defect; and associate the defect with a node in the assembly graph based on the subset of features.

In one example, the computer system can: access historical manufacturing data for a set of assembly units; detect anomalous values of a first assembly component (or process) from this historical manufacturing data; detect anomalous values of a second assembly component (or process); detect anomalous values of a third assembly component (or process); and detect co-occurrence between these anomalies in assembly units exhibiting a defect. In this example, the computer system can: compute first-order correlations between the first assembly component and the defect, the second assembly component and the defect, and the third assembly component and the defect; and compute second-order correlations between combinations (and/or permutations) of the first assembly component and the second assembly component, the second assembly component and the third assembly component, and the first assembly component and the third assembly component relative to the defect.

In one variation, the computer system can: detect that anomalous values of the first assembly component strongly correlate with anomalous values of the second assembly component; detect that anomalous values of the second assembly component strongly correlate with anomalous values of the third assembly component; and detect that anomalous values of the third assembly component strongly correlate with the defect. In this variation, the computer system can, therefore, infer a sequential causal relationship in which the first assembly component causes the second assembly component to deviate, the second assembly component causes the third assembly component to deviate, and the third assembly component causes the defect.

In another variation, the computer system can: detect that anomalous values of the second assembly component precede and strongly correlate with anomalous values of the first assembly component; and detect that anomalous values of the first assembly component strongly correlate with the defect, while anomalous values of the third assembly component exhibit weak (or inconsistent) correlation with the defect. In this variation, the computer system can, therefore, infer a reordered causal relationship in which the second assembly component causes the first assembly component to deviate, and the first assembly component causes the defect, independent of the third assembly component.

In another variation, the computer system can: detect that anomalous values of the first assembly component, in singularity, do not strongly correlate with the defect; detect that anomalous values of the second assembly component, in singularity, do not strongly correlate with the defect; and detect that concurrent anomalous values of the first assembly component and the second assembly component exhibit a strong joint correlation with the defect. In this variation, the computer system can infer a combinatorial causal relationship in which the first assembly component and the second assembly component jointly cause the defect, while the third assembly component is not causally significant.

Additionally, the computer system can evaluate temporal ordering of the first assembly component, the second assembly component, and the third assembly component within the assembly sequence to distinguish upstream contributors from downstream effects by determining whether anomalous values of the first assembly component occur before anomalous values of the second assembly component and whether anomalous values of the second assembly component occur before anomalous values of the third assembly component in assembly units exhibiting the defect.

Accordingly, the computer system can leverage first-order and n-order correlations between the first assembly component, the second assembly component, the third assembly component, and the defect-constrained by temporal ordering defined in the assembly graph—to infer sequential, reordered, combinatorial, upstream, downstream, and parallel causal relationships and to bound root cause analysis to a causally consistent subset of assembly components and assembly processes.

In another variation, the computer system can determine that data associated with the first assembly component (or process) is incomplete or absent for a subset of assembly units exhibiting a defect. In this variation, the computer system can access historical manufacturing data associated with a second manufacturing facility assembling the same assembly unit type and can compute correlations between the first assembly component, the second assembly component, the third assembly component, and the defect based on data collected at the second manufacturing facility. The computer system can then map these correlations onto the assembly graph associated with the first manufacturing facility and can infer a likely causal contribution of the first assembly component at the first manufacturing facility based on similarity of assembly sequences, component identifiers, and process definitions between the two facilities.

### 8. Root Cause Detection

Generally, the computer system can: access a defect log for a particular assembly unit of a particular assembly unit type; access an assembly graph for the particular assembly unit type; based on the defect log, identify a location associated with the defect; extract a set of visual and non-visual features proximal the location associated with the defect; map the set of visual and non-visual features to nodes and edges in the assembly graph; extract a set of correlations to the defect from nodes and edges in the assembly graph; and predict a root cause of the defect according to the set of correlations.

### 8.1 Defect Detection+Location

Generally, the computer system can: identify a location associated with the defect based on a defect log associated with a particular assembly unit; and extract a set of visual and non-visual features proximal the location associated with the defect.

In particular, the computer system can access a defect log associated with the assembly unit and can extract data identifying: a failed functional test, an anomalous measurement, an assembly stage at which the failure was first detected, and/or a component associated with the failure. The computer system can then associate the failed test or anomalous measurement with a subset of assembly components and assembly processes that physically introduce, modify, or enclose the portion of the assembly unit implicated by the defect.

In one implementation, the computer system can identify a first assembly stage at which a component associated with the defect is introduced into the assembly unit and can identify a subsequent assembly stage after which downstream actions no longer physically interact with, alter, or influence that component. The computer system can thereby bound the defect to a defined region of the assembly unit spanning between these assembly stages and can restrict subsequent analysis to visual and nonvisual features captured within this bounded region.

Therefore, the computer system can localize the defect within the assembly unit based on manufacturing and test data, without analyzing unrelated portions of the assembly unit.

### 8.2 Feature Extraction

As described above, the computer system can: identify a location of the defect; and extract a set of visual and non-visual features associated with the defect. For example, the computer system can isolate the first set of visual features spatially proximal the location of the defect on the first assembly unit, such as by isolating a first set of assembly components spatially proximal the location of the defect on the first assembly unit.

Generally, the computer system identifies multiple (e.g., “n,” or “many”) features representative of an assembly unit depicted in an inspection image, characterizes these features, and aggregates these features into a multi-dimensional (e.g., “n-dimensional”) vector or other container uniquely representing this assembly unit.

In one implementation, the computer system implements a feature classifier that defines: types of single-order features (e.g., corners, edges, areas, gradients); types of second-order features constructed from multiple single-order features (e.g., edge orientation and gradient magnitude of an edge, polarity and strength of a blob); metrics for relative positions and orientations of multiple features; and/or prioritization for detecting and extracting features from an inspection image. The computer system can then apply this feature classifier to the full height and width of a region of the inspection image representing the assembly unit. For example, the computer system can implement low-level computer vision techniques (e.g., edge detection, ridge detection), curvature-based computer vision techniques (e.g., changing intensity, autocorrelation), and/or shape-based computer vision techniques (e.g., thresholding, blob extraction, template matching)—according to the feature classifier—to detect n-number of highest-priority features representing the assembly unit in the inspection image.

The computer system can then extract a local image patch around these features, such as in the form of a multi-dimensional (e.g., n-dimensional) feature vector (hereinafter a “vector”) representing a corpus (e.g., thousands, millions) of features extracted from the inspection image. For example, this vector can define a “fingerprint” that uniquely represents visual features present on the assembly unit and depicted in this particular inspection image.

The computer system can repeat this process for other inspection images-such as by processing these inspection images in a batch or by processing new inspection images individually upon receipt from an optical inspection station—to generate a population of vectors uniquely representing each assembly unit in this population of imaged assembly units.

Additionally, the computer system can aggregate non-visual manufacturing data representing a set of manufacturing inputs and conditions along the assembly line during manufacturing of the set of assembly units. Generally, the computer system collects other manufacturing-related data for assembly units manufactured along the assembly line, including both control inputs and measurement outputs (hereinafter “manufacturing data”). For example, the computer system can access control inputs including: inputs into the assembly line or manufacturing process, such as equipment settings, tool paths, and/or work instructions (e.g., a torque setting for an electronic screwdriver manipulated manually by a technician or operator); component sources; an assembly station technician identifier; etc. The computer system can additionally access measurement outputs including: unit-specific sensor data; ambient sensor data; actual assembly equipment process data (e.g., the actual torque measured by an electronic screwdriver during installation of a screw into a particular assembly unit); etc. Measurement outputs can also include feature vectors generated from features detected in inspection images described above. The computer system can also access assembly unit “outcome data,” such as indicating presence or absence of specific functional or aesthetic defects in assembly units and execute Blocks of the method S100 to derive correlations between these manufacturing inputs (i.e., hard inputs and measurement and test result data) and assembly unit outcomes (i.e., presence of absence of specific functional or aesthetic defects).

For example, the computer system can isolate a second set of nonvisual features associated with the defect according to the defect log, including isolating a first set of assembly processes associated with the first set of assembly components.

In particular, the computer system can interface with: ambient sensors to collect temperature and humidity data near the assembly line; scales to collect assembly unit weights at particular stages of assembly; part or assembly test rigs to collect assembly unit test results, such as generated by antenna test rigs, touch sensor test and calibration rigs, or environmental test rigs; assembly tools, such as a screwdriver to collect screwdriver torque and dwell time values at a particular assembly stage; fixture and jig data, such as to collect an assembly force, weight distribution, or component presence report generated by sensors integrated into an assembly jig; robotic assembly systems, such as tool paths or log files of a robotic arm or other robotic manipulator-located along the assembly line-during installation of a part onto an assembly; etc. In this example, the user may link the computer system to these sensors and actuators directly, and the computer system can ingest these data in real-time. Alternatively, the user may link the computer system to the database containing these manufacturing data, and the computer system can asynchronously ingest these data.

The computer system can also access: upstream IQC data for parts and subassemblies supplied to the assembly line; dimensional data and test data for these supplied parts and subassemblies; two-dimensional or three-dimensional CAD models or drawings of parts and subassemblies of the assembly type; dimension, tolerance, and material specifications for these parts and subassemblies; cosmetic templates for the assembly type; data from robotic assembly equipment, CNC tools, injection-molding equipment, and other manufacturing equipment; work instructions or standard operating procedures (e.g., for humans) at assembly stations along the assembly line; etc.

Furthermore, the computer system can access an assembly specification for this assembly type, such as: an order of assembly of individual components; assembly steps and processes; assembly tools, jigs, and fixtures and related specifications; robotic assembly rigs and related processes and tool paths; adhesive types and specifications; etc. for the assembly type.

However, the computer system can implement any other method and technique to ingest structured, unstructured, and/or semi-structured manufacturing data in any other format and related to parts and subassemblies supplied to the assembly line, related to assembly of these parts and subassemblies, etc.

In one implementation, the computer system can identify nonvisual features based on a feature map correlating nonvisual features to physical locations on an assembly unit.

In particular, the computer system can isolate the second set of nonvisual features associated with the defect according to the defect log by: accessing an assembly type of the first assembly unit based on the defect log; accessing a feature map linking non-visual features to locations within assembly units of the assembly type; accessing an inspection image depicting the first assembly unit and recorded by an optical inspection station during manufacturing of the assembly unit; projecting the location of the defect onto the inspection image; and aggregating the second set of non-visual features associated with locations proximal the location of the defect.

In this implementation, the computer system can link, connect, or otherwise define relationships between specific data streams (e.g., from sensors and actuators along the assembly line), actuator and operator log files, and/or other non-visual manufacturing-related data related to operation of the assembly line. For example, a user may define a bounding box encompassing the entirety of a representative assembly unit depicted in an inspection image and link this bounding box to ambient temperature and humidity data streams recorded by environmental sensors proximal an assembly station immediately preceding an optical inspection station that recorded this inspection image. In another example, the user may define a bounding box around a threaded fastener in an inspection image of a representative assembly unit at a particular assembly stage and link this bounding box to a data stream for torque, dwell, and rotation count values output by a screw driver at an assembly station on the assembly line immediately preceding an optical inspection station that recorded this inspection image. The computer system can interface with the user to repeat this process for each other manufacturing step, data stream, or non-visual manufacturing-related data source imported into the new inspection process in order to link these steps, data streams, and data sources to particular features, components, or regions depicted in representative inspection images of assembly units of this assembly type at particular stages of assembly.

The computer system can similarly interface with the user to link component supplier data, component characteristics, and/or other component-related data to particular features, components, or regions depicted in representative inspection images of assembly units of this assembly type at particular stages of assembly.

The computer system can extract spatial links between these non-visual manufacturing data streams and features, components, or regions depicted in representative inspection images of assembly units of this assembly type at particular stages of assembly thus tagged or annotated by the user within the user portal. The computer system can then compile these spatial links into a feature map defining spatial associations between: these non-visual manufacturing data streams; stages of assembly of the assembly type (e.g., defining relative time markers for manufacturing cycle of the assembly type); and (relative) physical locations of particular features, components, and/or regions in this assembly type.

### 8.3 Bounded Graph Region+Correlation Matrix+Root Cause

Generally, the computer system can predict a root cause of a particular defect based on correlations between assembly components, assembly processes, and the defect. In particular, the computer system can: define a bounded region of the assembly graph, including a first subset of nodes and a first subset of edges, based on the first set of visual features and the second set of nonvisual features; isolate a first set of features defined in the bounded region of the assembly graph; and, based on the assembly graph and for each feature in the first set of features, generate a correlation, in a set of correlations, between the feature and the defect.

The computer system can then: assemble the set of correlations into a correlation matrix; isolate a first subset of features, in the first set of features, exhibiting correlations, in the set of correlations, exceeding a threshold correlation; generate a prediction of a root cause of the defect, the root cause specifying the first subset of features; and serve the prediction of the root cause of the defect to an operator portal.

In one implementation, the computer system can define the bounded region of the graph based on introduction of a particular assembly component into the first assembly unit. For example, the computer system can: identify a first edge representing introduction of a particular assembly component corresponding to the first set of visual features; identify a second edge corresponding to a latest assembly process configured to influence the particular assembly component corresponding to the first set of visual features; and define the bounded region of the assembly graph including the first subset of nodes and the first subset of edges between the first graph element and the second graph element.

In another example, the computer system can extract a description (e.g., a natural language description) of the defect, such as the defect defined by explicit test failures. The computer system can then map the defect to a particular assembly stage, a subset of assembly stages, a particular assembly component, a particular subassembly, and/or a particular subset of assembly components based on the description of the defect, such as based on an inspection station—and temporal/spatial locations of this inspection station—that detected the defect.

The computer system can then: map the defect to a particular subset of nodes in the assembly graph based on the particular assembly component, the particular subassembly, and/or the particular subset of assembly components; and/or map the defect to a particular subset of edges in the assembly graph based on the particular assembly stage and/or the subset of assembly stages. In particular, the computer system can map the defect to a particular subsection (e.g., the subset of nodes, the subset of edges) of the assembly graph based on a physical location of the defect (e.g., an antenna, a GPU chip) specified in the defect log. More specifically, the computer system can: access the defect log associated with the defect; and identify metadata specifying when and where the defect was detected (e.g., at a first inspection stage, during a burn-in test, during a wireless validation routine). The computer system can then: access the assembly graph defining relationships between assembly components (as nodes) and assembly processes (as edges); and traverse the assembly graph according to nodes causally linked to the defect type and/or physically associated with the region of the assembly unit based on assembly components within the region. Rather than traversing the entire assembly graph, the computer system can select candidate nodes based on (i) a defect classification (e.g., thermal defect, electrical defect, mechanical defect, software failure) and/or (ii) a physical location or functional subsystem implicated by the defect. The computer system can then identify an intersection of candidate nodes representing assembly stages that are both physically proximal and causally linked to the detected defect, thereby identifying an assembly stage associated with the defect based on defined dependencies in the assembly graph.

In one implementation, the computer system can generate a correlation matrix, based on the assembly graph, specifying a set of correlations between the first set of visual features and the defect; and the second set of nonvisual features and the defect.

In one implementation, the computer system can assemble the correlation matrix defining first-order correlations between distinct assembly components, distinct assembly processes, and the defect. In particular, the computer system can: for each visual feature in the first set of visual features, calculate a first correlation, in a first set of correlations, between the visual feature and the defect; for each non-visual feature in the second set of non-visual features, calculate a second correlation, in a second set of correlations, between the non-visual feature and the defect; and assemble the first set of correlations and the second set of correlations into the correlation matrix.

Additionally or alternatively, the computer system can assemble the correlation matrix defining multi-order (e.g., ‘n’-order) correlations between distinct assembly components, distinct assembly processes, and the defect, such as sequences of nodes, representing assembly components, contributing to the defect, a combination of nodes and/or edges, and/or any other combination (or permutation) of nodes and edges.

For example, for each visual feature in the first set of visual features, the computer system can: calculate a first correlation, in a first set of correlations, between the visual feature and the defect; and calculate a second correlation, in the first set of correlations, between the visual feature, a second visual feature in the first set of visual features, and the defect. In this example, for each non-visual feature in the second set of non-visual features, the computer system can: calculate a third correlation, in a second set of correlations, between the non-visual feature and the defect; and calculate a fourth correlation, in the second set of correlations, between the non-visual feature, a second non-visual feature in the second set of non-visual features, and the defect. The computer system can then assemble the first set of correlations and the second set of correlations into the correlation matrix.

Generally, the computer system can: isolate a section of the assembly graph based on the location of the defect; and generate the correlation matrix based on the section of the assembly graph. In particular, the computer system can: isolate a first subset of nodes, in the assembly graph, representing the first set of assembly components; isolate a first subset of edges, in the assembly graph, representing the first set of assembly processes; extract a first set of correlations between the first subset of nodes and the defect based on the assembly graph; extract a second set of correlations between the first subset of edges and the defect based on the assembly graph; and assemble the first set of correlations and the second set of correlations into the correlation matrix.

In one variation, the computer system can: isolate a subset of nodes in the assembly graph; and rank the subset of nodes as candidate root causes based on correlations between each node, in the subset of nodes, and the defect. For example, the computer system can: isolate a subset of nodes in the assembly graph; for each node, in the subset of nodes, calculate a confidence score-proportional to a correlation between the node and the defect-representing a confidence in the node causing the defect; and present the subset of nodes, ranked according to the confidence scores, to an operator via an operator portal. The computer system can then receive selection of a particular node as a root cause of the defect.

Additionally or alternatively, the computer system can: isolate a subset of nodes in the assembly graph; for each node, in the subset of nodes, calculate a confidence score-proportional to a correlation between the node and the defect-representing a confidence in the node causing the defect; and select a first node, in the subset of nodes, as a predicted root cause of the defect in response to the first node corresponding to a confidence score exceeding a threshold confidence score (e.g., 80%, 95%).

In a similar variation, the computer system can: isolate a subset of edges in the assembly graph; and rank the subset of edges as candidate root causes based on correlations between each node, in the subset of edges, and the defect. For example, the computer system can: isolate a subset of edges in the assembly graph; for each edge, in the subset of edges, calculate a confidence score-proportional to a correlation between the edge and the defect-representing a confidence in the edge causing the defect; and present the subset of edges, ranked according to the confidence scores, to an operator via an operator portal. The computer system can then: receive selection of a particular edge as a root cause of the defect.

Additionally or alternatively, the computer system can: isolate a subset of edges in the assembly graph; for each edge, in the subset of edges, calculate a confidence score-proportional to a correlation between the edge and the defect-representing a confidence in the edge causing the defect; and select a first edge, in the subset of edges, as a predicted root cause of the defect in response to the first edge corresponding to a confidence score exceeding a threshold confidence score (e.g., 80%, 95%).

Therefore, by isolating a subsection of the assembly graph physically and causally linked to the defect and calculating first-order and multi-order correlations between visual features, non-visual manufacturing features, and the defect within this subsection, the computer system can: constrain root cause analysis to assembly components and assembly processes proximal to and (strongly) associated with the defect; generate confidence-ranked candidate nodes and/or edges representing predicted root causes; and selectively output a root cause prediction exceeding a threshold confidence to the operator portal without traversing unrelated regions of the assembly graph.

### 9. Assembly Unit Defect Trends

Generally, the computer system can aggregate defect data, predicted root causes, and associated assembly-graph regions across a population of assembly units in order to identify defect trends and recurring causal patterns. In particular, the computer system can: group assembly units according to assembly unit type, configuration, and/or manufacturing facility; aggregate defect classifications and corresponding root cause predictions within each group of assembly units; and calculate trend metrics representing frequencies, rates of occurrence over time, and correlation strengths between subsets of nodes and/or edges in the assembly graph and detected defects across the grouped assembly units.

In one implementation, the computer system can distinguish between one-off failures and systemic issues by comparing defect incidence and root cause recurrence across grouped assembly units. For example, a defect associated with a single assembly unit and linked to a low-frequency node in the assembly graph can be classified as an isolated failure, whereas repeated defects across assembly units of a common configuration and mapped to a common bounded region of the assembly graph can be classified as a systemic issue. Therefore, by aggregating defect data and root cause predictions across assembly units and grouping these data by assembly unit type, configuration, and facility, the computer system can: identify recurring root causes; detect emerging defect trends; and refine weighting, dependency relationships, and traversal bounds within the assembly graph based on observed defect patterns.

### 9.1 Inspection Stages+Sensor Deployment

In one implementation, the computer system can derive locations of sensors (or inspection stations) based on defects across a population of manufacturing facilities and predicted root causes of these defects.

In particular, the computer system can derive locations of sensors (or inspection stations) based on: predicted root causes of a set of defects; predicted risk scores associated with the set of defects; and resource scores associated with the set of defects. For example, the computer system can, for a first defect corresponding to a predicted root cause at a particular assembly stage, access and/or calculate a threshold count of intermediate assembly stages between the particular assembly stage and an inspection station-configured to detect the first defect-proportional to a risk score of the first defect and a resource score of the first defect.

In particular, the computer system can: identify a first inspection stage associated with detection of the defect according to the defect log in Block S160; identify a first assembly stage, in the set of assembly processes, associated with the defect based on the first subset of features in Block S162; calculate a count of intermediate assembly stages between the first assembly stage, associated with the defect, and the first inspection stage in Block S164; and, in response to the count of intermediate assembly stages exceeding a threshold count of intermediate assembly stages, recommend installation of the first inspection stage immediately succeeding the first assembly stage in Block S165.

In the foregoing implementation, the computer system can: calculate a count of assembly components, in a first set of assembly components required for repair of the defect associated with the first assembly unit in Block S170; identify a defect assembly stage associated with onset of the defect based on the set of features; calculate a downstream propagation stage count representing propagation of the defect to downstream assembly stages based on the defect assembly stage in Block S172; calculate a composite defect value based on the count of assembly components and the downstream propagation stage count in Block S174; and calculate the threshold count of intermediate assembly stages proportional to the composite defect value in Block S176.

In this example, in response to detecting a particular sensor (or inspection stage) detecting a count of defects falling below a threshold count of defects, the computer system can recommend relocation of the first inspection stage to a downstream position in the assembly process, thereby reducing inspection resource consumption while maintaining detection of defects exhibiting lower propagation risk and lower rework burden. For example, the computer system can: identify a first inspection stage associated with detection of the defect according to the defect log; identify a first assembly stage, in the set of assembly processes, associated with the defect based on the first subset of features; calculate a resource score for rework of the first assembly unit based on a first set of assembly components required for rework of the first assembly unit and the first subset of features; calculate a risk score for the defect based on propagation of the defect to downstream assembly stages; calculate a composite defect score based on the resource score and the risk score; calculate a threshold count of intermediate assembly stages proportional to the composite defect score; calculate a count of intermediate assembly stages between the first assembly stage, associated with the defect, and the first inspection stage; and, in response to the count of intermediate assembly stages falling below the threshold count of intermediate assembly stages, recommend installation of the first inspection stage immediately succeeding a second assembly stage succeeding the first assembly stage and exceeding the threshold count of intermediate assembly stages from the first assembly stage.

Additionally or alternatively, the computer system can recommend removal of the inspection stage, such as in response to the sensor detecting a count of defects (or a frequency of defect detection) below a threshold count of defects. For example, the computer system can: access a corpus of defect logs associated with the set of assembly units; identify a first inspection stage associated with detection of the defect according to the set of defect logs in Block S180; calculate a count of assembly units, in the set of assembly units, exhibiting the defect in Block S182; and, in response to the count of assembly units falling below a threshold count of assembly units, recommend removal of the first inspection stage in Block S165.

Accordingly, the computer system can derive a recommended placement of sensors (or inspection stations) within the assembly process, such as based on resource consumption by these sensors in relation to risks of defects detected by these sensors.

Therefore, by deriving inspection stage placement and sensor location recommendations from root cause predictions bounded within the assembly graph and weighted by defect risk and resource scores, the computer system can: iteratively arrange a physical configuration of the assembly line, such as by repositioning or adding inspection stages proximal causally implicated assembly processes; and iteratively refine sensor deployment and data collection based on observed defect propagation, thereby maintaining alignment between defect analytics and manufacturing execution.

### 9.2 Inspection Stages: Refinement

In a similar implementation, the computer system can refine inspection stages (e.g., tests, sensors) based on root causes of defects.

In one example, the computer system can: access an inspection log specifying tests administered at a particular inspection stage; and, in response to detecting absence of a particular test configured to detect a particular defect-detected in the assembly unit—in the inspection log, recommend (or automatically append the inspection log with) addition of the particular test at the particular inspection stage.

In particular, the computer system can: identify a first assembly stage, in the set of assembly processes, associated with the defect based on the first subset of features; identify a first inspection stage succeeding the first assembly stage; access a set of sensor data captured by sensors deployed at the first inspection stage; derive a set of tests administered at the first inspection stage based on the set of sensor data; and, in response to detecting absence of a test configured to detect defects similar to the defect in the set of tests, recommend addition of the test configured to detect defects similar to the defect at the first inspection stage.

For example, the computer system can: identify a first assembly stage at which a fastener is installed into a housing based on a first subset of features associated with a defect indicating loosening of the fastener during operation; identify a first inspection stage succeeding the first assembly stage; access sensor data captured at the first inspection stage, including images of the housing and torque readings recorded during assembly; derive a set of tests administered at the first inspection stage based on the sensor data; and detect, in the set of tests, presence of a first test for verification of presence of the fastener, and absence of a second test configured to detect insufficient torque applied to the fastener. Accordingly, the computer system can recommend addition of a test, at the first inspection stage, configured to evaluate torque applied to the fastener in order to detect defects similar to the defect.

Additionally or alternatively, the computer system can refine thresholds of feature detection for this inspection station.

In particular, the computer system can: identify a first assembly stage, in the set of assembly processes, associated with the defect based on the first subset of features; identify a first inspection stage succeeding the first assembly stage; access an inspection log specifying tests administered at a particular inspection stage; and, in response to detecting presence of a particular test configured to detect a particular defect—detected in the assembly unit—in the inspection log, recommend (or automatically append the inspection log with) adjusting (e.g., tightening tolerance of) the particular test ranges at the particular inspection stage.

For example, the computer system can: identify a first assembly stage, in the set of assembly processes, associated with the defect based on the first subset of features in Block S162; identify a first inspection stage succeeding the first assembly stage in Block S160; access a set of sensor data captured by sensors deployed at the first inspection stage; and derive a set of tests administered at the first inspection stage based on the set of sensor data in Block S167. In response to detecting presence of a test configured to detect defects similar to the defect in the set of tests, the computer system can: access a tolerance range of the test; predict a test result for the first assembly unit on the test based on the defect log in Block S168; and decrease the tolerance range of the test to include the test result in Block S169.

In another example, the computer system can: identify a first assembly stage at which a connector is seated into a receptacle based on a first subset of features associated with an intermittent electrical defect; identify a first inspection stage succeeding the first assembly stage; access sensor data captured at the first inspection stage, including images and electrical continuity measurements; and derive a set of tests administered at the first inspection stage; and detect presence of an electrical continuity test configured to detect defects similar to the defect.

The computer system can then: access a tolerance range associated with the electrical continuity test; predict a test result for the first assembly unit based on the defect log, and recommend adjustment of the tolerance range (e.g., reducing the tolerance range, broadening the tolerance range) to include the test result for the first assembly unit. Accordingly, the computer system can decrease the tolerance range of the electrical continuity test such that future assembly units exhibiting similar conditions are identified at the first inspection stage.

Therefore, the computer system can execute Blocks of the method S100 to selectively modify inspection behavior at an inspection stage succeeding an assembly stage associated with a defect, such as by adding a test configured to detect defects similar to the defect and/or refining a tolerance range of an existing test, based on a subset of features identified as root causes of the defect, thereby improving detection of defects without introducing additional inspection stages.

### 10. Interfacility Transfer of Knowledge

Generally, the computer system can implement the methods and techniques described herein across multiple manufacturing facilities to derive inspection stage and/or sensor placement for defect detection according to historical inspection stage deployment. In particular, the computer system can: aggregate defect classifications, predicted root causes of these defects, inspection stage locations, and assembly graphs across a population of manufacturing facilities; compare locations of inspection stations relative to assembly stages-associated with a root cause (or origin) of the defect—for each inspection station; and recommend inspection stage deployment, relative to assembly stages, for a (new) manufacturing facility.

In particular, the computer system can: identify a first subset of assembly units, in the first set of assembly units manufactured at a first manufacturing facility, exhibiting the first defect; identify a first inspection station, in the first manufacturing facility, associated with detection of the first defect; identify a second subset of assembly units, in a second set of assembly units manufactured at a second manufacturing facility, exhibiting the first defect; identify a second inspection station, in the second manufacturing facility, associated with detection of the first defect; and, in response to the second inspection station preceding the first inspection station in an assembly sequence for manufacturing of assembly units, recommend relocation of the first inspection station to a first location corresponding to a second location of the second inspection station in Block S184.

For example, the computer system can: at a first manufacturing facility, detect a first defect type at a particular inspection stage succeeding a particular assembly stage; at a second manufacturing facility, detect the first defect type associated with an upstream inspection stage located closer to the particular assembly stage than at the first manufacturing facility. The computer system can then: recommend installation (or activation) of an inspection stage at the first manufacturing facility corresponding to the upstream inspection stage at the second manufacturing facility, thereby reducing a count of intermediate assembly stages between a predicted defect origin and a defect detection, thereby enabling earlier identification of the defect during manufacturing of assembly units.

In another implementation, the computer system can predict and/or recommend deployment of a distribution of sensors for a second manufacturing facility-similar to the first manufacturing facility-based on sensor locations and/or inspection station locations associated with the first manufacturing facility.

In one example, the computer system can: access a corpus of defect logs associated with a first set of assembly units manufactured at a first manufacturing facility and specifying a first corpus of defects associated with the first set of assembly units; extract a corpus of sensor data, captured by sensors at a set of inspection stations during manufacture of the first set of assembly units, from the corpus of defect logs; isolate a set of sensors associated with detection of the first corpus of defects based on the corpus of sensor data; for each sensor in the set of sensors, calculate a resource score proportional to a count of defects detected by the sensor; isolate a subset of sensors in the set of sensors, the subset of sensors exhibiting resource scores exceeding a threshold resource score; access an assembly configuration associated with a second manufacturing facility distinct from the first manufacturing facility; map the subset of sensors to corresponding inspection stages at the second manufacturing facility based on the assembly configuration; and recommend installation of the subset of sensors, at corresponding inspection stages, at the second manufacturing facility.

In the foregoing example, the computer system can additionally implement closed-loop controls to: update sensor placement recommendations and defect detection at the second manufacturing facility based on defects subsequently detected at the second manufacturing facility; refine weighting and dependency relationships within the corresponding assembly graph based on observed defect propagation; and iteratively adjust inspection stage location deployment to reduce a count of intermediate assembly stages between predicted defect origins and defect detection.

In the foregoing example, the computer system can additionally implement methods and techniques as described herein to iteratively analyze defect detection and error handling at the second manufacturing facility, such as for defects not detected at the first manufacturing facility. For example, the computer system can generate correlations between features (e.g., visual features, non-visual features) in the assembly unit (i.e., inspection data captured during manufacturing of the assembly unit) and the defect to derive and/or predict a root cause of the (new) defect.

In particular, the computer system can: access a second corpus of defect logs associated with a second set of assembly units manufactured at the second manufacturing facility and specifying a second corpus of defects associated with the second set of assembly units; identify a first defect, in the second corpus of defects, absent from the first corpus of defects in Block S196; isolate a defect log, in the second corpus of defect logs, specifying the first defect; derive a location of the first defect on a first assembly unit, in the second set of assembly units, based on the defect log; isolate a first set of visual features spatially proximal the location of the first defect on the first assembly unit; and isolate a second set of nonvisual features associated with the first defect according to the defect log. The computer system can then: access an assembly graph associated with the second set of assembly units and defining a set of assembly processes, for manufacturing of the set of assembly units, and corresponding defects; generate a correlation matrix, based on the assembly graph, specifying a set of correlations between the first set of visual features and the defect, and the second set of nonvisual features and the defect; isolate a first subset of features, in the first set of visual features and the second set of nonvisual features, exhibiting correlations, in the set of correlations, exceeding a threshold correlation; identify a first assembly stage, in the set of assembly processes, associated with the first subset of features; and recommend installation of an inspection stage immediately succeeding the first assembly stage, the inspection stage configured to detect the first subset of features.

Therefore, by aggregating defect classifications, predicted root causes, inspection-stage deployments, and assembly-graph structures across multiple manufacturing facilities, the computer system can: transfer defect detection locations-via inspection station locations-between manufacturing facilities; configure inspection infrastructure at new or underperforming manufacturing facilities based on historically effective sensor placements; and iteratively refine sensor deployment in response to newly observed defect patterns.

### 11. Variation: Machine-Readable Assembly Graph

In one variation, the computer system can construct a machine-readable assembly graph defining relationships between defects, functional domains, assembly stages, assembly components, and manufacturing inputs without enforcing a strictly hierarchical or tree-based dependency structure. In particular, the computer system can: define a network of nodes representing defects, functional domains, assembly processes, assembly components, and recorded manufacturing features; and define edges representing statistical associations, learned correlations, co-occurrence patterns, and inferred causal relationships derived from historical manufacturing data and defect logs.

In this variation, the computer system can dynamically construct and update associations between defects and candidate root causes based on observed data across assembly units and across manufacturing facilities. For example, the computer system can: detect a defect based on a failed functional test or anomaly in test logs; identify a functional domain associated with the defect; select a set of candidate root causes associated with the functional domain based on historical defect data; examine manufacturing inputs associated with the assembly unit corresponding to the set of candidate root causes; compare observed manufacturing inputs against expected or nominal values; and predict a likely root cause based on deviations between observed inputs and expected inputs. The computer system can then repeat methods and techniques as described herein independently for each assembly unit in a particular set of assembly units, such as for each assembly unit at an assembly line within a manufacturing facility.

In particular, the computer system can: access a corpus of defect logs; derive statistical associations (e.g., correlations) between defects and subsets of manufacturing inputs across assembly units; generate weighted edges between assembly component nodes and manufacturing input nodes proportional to correlation strength; and update these weights as additional defect data are recorded. Accordingly, the computer system can dynamically update the machine-readable assembly graph over time to encode probabilistic relationships between defects and candidate causes inferred directly from manufacturing data rather than manually defined process dependencies.

Therefore, by constructing and iteratively updating a machine readable network of relationships between defects, assembly stages, and manufacturing inputs, the computer system can extend the root cause prediction techniques described herein to assembly environments lacking complete or static process documentation, infer likely causes of newly observed defects based on learned associations across prior assembly units, and continuously refine defect analysis as additional manufacturing data are collected, thereby improving robustness, adaptability, and scalability of defect detection and root cause inference across dynamic manufacturing systems.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

1. A method comprising:
for a first assembly unit in a set of assembly units:
accessing a defect log associated with the first assembly unit;
isolating a location of a defect on the first assembly unit based on the defect log;
isolating a first set of visual features spatially proximal the location of the defect on the first assembly unit;
isolating a second set of nonvisual features associated with the defect according to the defect log;
accessing an assembly graph associated with the set of assembly units and defining:
a first set of nodes representing assembly components and subassemblies associated with manufacturing of the set of assembly units, the first set of nodes labeled with corresponding defects; and
a set of edges, connecting nodes in the set of nodes and representing a set of assembly processes for manufacturing of the set of assembly units, the set of edges labeled with corresponding defects;
defining a bounded region of the assembly graph, comprising a first subset of nodes and a first subset of edges, based on the first set of visual features and the second set of nonvisual features;
isolating a first set of features defined in the bounded region of the assembly graph;
based on the assembly graph:
for each feature in the first set of features, generating a correlation, in a set of correlations, between the feature and the defect; and
assembling the set of correlations into a correlation matrix;
isolating a first subset of features, in the first set of features, exhibiting correlations, in the set of correlations, exceeding a threshold correlation;
generating a prediction of a root cause of the defect, the root cause specifying the first subset of features; and
serving the prediction of the root cause of the defect to an operator portal.

2. The method of claim, further comprising:
identifying a first inspection stage associated with detection of the defect according to the defect log;
identifying a first assembly stage, in the set of assembly processes, associated with the defect based on the first subset of features;
calculating a count of intermediate assembly stages between the first assembly stage, associated with the defect, and the first inspection stage; and
in response to the count of intermediate assembly stages exceeding a threshold count, recommending installation of the first inspection stage immediately succeeding the first assembly stage.

3. The method of claim, further comprising:
calculating a count of assembly components, in a first set of assembly components required for repair of the defect associated with the first assembly unit;
identifying a defect assembly stage associated with onset of the defect based on the set of features;
calculating a downstream propagation stage count representing propagation of the defect to downstream assembly stages based on the defect assembly stage;
calculating a composite defect value based on the count of assembly components and the downstream propagation stage count; and
calculating the threshold count of intermediate assembly stages proportional to the composite defect value.

4. The method of claim, wherein defining the bounded region of the assembly graph comprises:
identifying a first edge representing introduction of a particular assembly component corresponding to the first set of visual features;
identifying a second edge corresponding to a latest assembly process configured to influence the particular assembly component corresponding to the first set of visual features; and
defining the bounded region of the assembly graph comprising the first subset of nodes and the first subset of edges between the first graph element and the second graph element.

5. The method of claim, further comprising:
accessing an assembly specification specifying the set of assembly processes for the set of assembly units;
accessing a log of manufacturing inputs representing a corpus of non-visual and visual features captured during manufacturing of the set of assembly units;
deriving a set of assembly components and subassemblies introduced during manufacturing of the set of assembly units;
defining the set of nodes, each node in the set of nodes representing an assembly component in the set of assembly components;
defining the set of edges, each edge in the set of edges representing an assembly action in the set of assembly processes and connecting nodes corresponding to assembly components joined during the assembly action; and
generating the assembly graph comprising the set of nodes and the set of edges.

6. The method of claim, further comprising:
accessing a set of historical defect logs for the set of assembly units, the set of historical defect logs identifying defective assembly units in the set of assembly units; and
for each defect specified in the set of historical defect logs:
for each feature in the corpus of non-visual and visual features:
identifying an anomaly value for the feature based on a distribution of feature values for assembly units, in the set of assembly units, exhibiting the defect;
identifying a target subset of features, in the corpus of non-visual and visual features, exhibiting anomaly values exceeding a threshold anomaly value;
for each feature in the target subset of features:
generating a correlation between the feature and the defect based on the anomaly value;
identifying a graph feature, in the assembly graph, associated with the feature; and
associating the correlation and the defect with the graph feature;
identifying a root cause of the defect based on the target subset of features and corresponding correlations between features, in the target subset of features, and the defect; and
associating the root cause with graph features in the assembly graph corresponding to features in the subset of target features.

7. The method of claim:
wherein generating the correlation, in a set of correlations, between the feature and the defect comprises, for each feature in the set of features:
generating a first-order correlation, in a set of first-order correlations, between the feature and the defect; and
generating a second-order correlation, in a set of second-order correlations, between the feature, a second feature in the set of features, and the defect;
wherein assembling the set of correlations into the correlation matrix comprises:
assembling the set of first-order correlations and the set of second-order correlations into the correlation matrix; and
wherein isolating the first subset of features comprises:
detecting a target second-order correlation, between a first visual feature and a second nonvisual feature and the defect, exceeding the threshold correlation; and
isolating the first subset of features comprising the first visual feature and the second nonvisual feature.

8. The method of claim, wherein isolating the second set of nonvisual features associated with the defect according to the defect log comprises:
accessing an assembly type of the first assembly unit based on the defect log;
accessing a feature map linking non-visual features to locations within assembly units of the assembly type;
accessing an inspection image depicting the first assembly unit and recorded by an optical inspection station during manufacturing of the first assembly unit;
projecting the location of the defect onto the inspection image; and
aggregating the second set of non-visual features associated with locations proximal the location of the defect.

9. The method of claim:
wherein isolating the first set of visual features spatially proximal the location of the defect on the first assembly unit comprises isolating a first set of assembly components spatially proximal the location of the defect on the first assembly unit;
wherein isolating the second set of nonvisual features associated with the defect according to the defect log comprises isolating a first set of assembly processes associated with the first set of assembly components;
wherein isolating the first set of features defined in the bounded region of the assembly graph comprises:
isolating a first subset of nodes, in the assembly graph, representing the first set of assembly components; and
isolating a first subset of edges, in the assembly graph, representing the first set of assembly processes;
wherein generating the correlation, in the set of correlations, between the feature and the defect comprises:
extracting a first set of correlations between the first subset of nodes and the defect based on the assembly graph; and
extracting a second set of correlations between the first subset of edges and the defect based on the assembly graph; and
wherein assembling the set of correlations into the correlation matrix comprises:
assembling the first set of correlations and the second set of correlations into the correlation matrix.

10. The method of claim, further comprising:
accessing a corpus of inspection images, captured by optical sensors installed at a set of inspection stations, of the set of assembly units;
deriving a set of assembly components associated with manufacturing of the set of assembly units based on the corpus of inspection images;
based on timestamps of inspection images in the corpus of inspection images, temporally ordering the corpus of inspection images to derive an assembly sequence for manufacturing of assembly units in the set of assembly units;
defining the set of assembly processes for manufacturing of the set of assembly units based on the assembly sequence and visual differences between pairs of inspection images in the corpus of inspection images;
defining the first set of nodes, each node in the first set of nodes identifying an assembly component in the set of assembly components;
defining the first set of edges, each edge in the first set of edges identifying an assembly process, in the set of assembly processes, and linking assembly components in the set of assembly components;
generating the assembly graph comprising the first set of nodes and the first set of edges;
accessing a set of defect logs associated with the set of assembly units; and
for each defect identified in the set of defect logs:
isolating a subset of features associated with the defect; and
associating the defect with a node in the assembly graph based on the subset of features.

11. The method of claim, further comprising:
identifying a first assembly stage, in the set of assembly processes, associated with the defect based on the first subset of features;
identifying a first inspection stage succeeding the first assembly stage;
accessing a set of sensor data captured by sensors deployed at the first inspection stage;
deriving a set of tests administered at the first inspection stage based on the set of sensor data; and
in response to detecting absence of a test configured to detect defects similar to the defect in the set of tests, recommending addition of the test configured to detect defects similar to the defect at the first inspection stage.

12. The method of claim, further comprising:
identifying a first assembly stage, in the set of assembly processes, associated with the defect based on the first subset of features;
identifying a first inspection stage succeeding the first assembly stage;
accessing a set of sensor data captured by sensors deployed at the first inspection stage;
deriving a set of tests administered at the first inspection stage based on the set of sensor data; and
in response to detecting presence of a test configured to detect defects similar to the defect in the set of tests:
accessing a tolerance range of the test;
predicting a test result for the first assembly unit on the test based on the defect log; and
decreasing the tolerance range of the test to include the test result.

13. The method of claim, further comprising:
identifying a first inspection stage associated with detection of the defect according to the defect log;
identifying a first assembly stage, in the set of assembly processes, associated with the defect based on the first subset of features;
calculating a count of assembly components, in a first set of assembly components required for repair of the defect associated with the first assembly unit;
identifying a defect assembly stage associated with onset of the defect based on the set of features;
calculating a downstream propagation stage count representing propagation of the defect to downstream assembly stages based on the defect assembly stage;
calculating a composite defect value based on the count of assembly components and the downstream propagation stage count;
calculating the threshold count of intermediate assembly stages proportional to the composite defect value;
calculating a count of intermediate assembly stages between the first assembly stage, associated with the defect, and the first inspection stage; and
in response to the count of intermediate assembly stages falling below the threshold count of intermediate assembly stages, recommending installation of the first inspection stage immediately succeeding a second assembly stage succeeding the first assembly stage and exceeding the threshold count of intermediate assembly stages from the first assembly stage.

14. The method of claim, further comprising:
accessing a corpus of defect logs associated with the set of assembly units;
identifying a first inspection stage associated with detection of the defect according to the set of defect logs;
calculating a count of assembly units, in the set of assembly units, exhibiting the defect; and
in response to the count of assembly units falling below a threshold count of assembly units, recommending removal of the first inspection stage.

15. A method comprising:
accessing a defect log associated with a first assembly unit in a first set of assembly units;
deriving a location of a defect on the first assembly unit based on the defect log;
isolating a first set of visual features spatially proximal the location of the defect on the first assembly unit;
isolating a second set of nonvisual features associated with the defect according to the defect log;
for each visual feature in the first set of visual features, calculating a first correlation, in a first set of correlations, between the visual feature and the defect;
for each non-visual feature in the second set of non-visual features, calculating a second correlation, in a second set of correlations, between the non-visual feature and the defect;
assembling the first set of correlations and the second set of correlations into a correlation matrix;
isolating a first subset of features, in the first set of visual features and the second set of nonvisual features, corresponding to correlations in the correlation matrix exceeding a threshold correlation;
generating a prediction of a root cause of the defect, the root cause specifying the first subset of features; and
serving the prediction of the root cause of the defect to an operator portal.

16. The method of claim, further comprising:
identifying a first inspection stage associated with detection of the defect according to the defect log;
identifying a first assembly stage, in the set of assembly processes, associated with the defect based on the first subset of features;
calculating a count of intermediate assembly stages between the first assembly stage, associated with the defect, and the first inspection stage; and
in response to the count of intermediate assembly stages exceeding a threshold count, recommending installation of the first inspection stage immediately succeeding the first assembly stage.

17. The method of claim, further comprising:
identifying a first inspection stage associated with detection of the defect according to the defect log;
identifying a first assembly stage, in the set of assembly processes, associated with the defect based on the first subset of features;
calculating a count of intermediate assembly stages between the first assembly stage, associated with the defect, and the first inspection stage; and
in response to the count of intermediate assembly stages exceeding a threshold count, recommending installation of the first inspection stage immediately succeeding the first assembly stage.

18. The method of claim, further comprising:
identifying a first subset of assembly units, in the first set of assembly units manufactured at a first manufacturing facility, exhibiting the first defect;
identifying a first inspection station, in the first manufacturing facility, associated with detection of the first defect;
identifying a second subset of assembly units, in a second set of assembly units manufactured at a second manufacturing facility, exhibiting the first defect;
identifying a second inspection station, in the second manufacturing facility, associated with detection of the first defect; and
in response to the second inspection station preceding the first inspection station in an assembly sequence for manufacturing of assembly units, recommending relocation of the first inspection station to a first location corresponding to a second location of the second inspection station in the assembly sequence.

19. A method comprising:
accessing a corpus of defect logs associated with a first set of assembly units manufactured at a first manufacturing facility and specifying a first corpus of defects associated with the first set of assembly units;
extracting a corpus of sensor data, captured by sensors at a set of inspection stations during manufacture of the first set of assembly units, from the corpus of defect logs;
isolating a set of sensors associated with detection of the first corpus of defects based on the corpus of sensor data;
for each sensor in the set of sensors, calculating a resource score proportional to a count of defects detected by the sensor;
isolating a subset of sensors in the set of sensors, the subset of sensors exhibiting resource scores exceeding a threshold resource score;
accessing an assembly configuration associated with a second manufacturing facility distinct from the first manufacturing facility;
mapping the subset of sensors to corresponding inspection stages at the second manufacturing facility based on the assembly configuration; and
recommending installation of the subset of sensors, at corresponding inspection stages, at the second manufacturing facility.

20. The method of claim, further comprising:
accessing a second corpus of defect logs associated with a second set of assembly units manufactured at the second manufacturing facility and specifying a second corpus of defects associated with the second set of assembly units;
identifying a first defect, in the second corpus of defects, absent from the first corpus of defects;
isolating a defect log, in the second corpus of defect logs, specifying the first defect;
deriving a location of the first defect on a first assembly unit, in the second set of assembly units, based on the defect log;
isolating a first set of features associated with the location of the first defect on the first assembly unit;
accessing an assembly graph associated with the second set of assembly units and defining a set of assembly processes, for manufacturing of the set of assembly units, and corresponding defects;
defining a bounded region of the assembly graph, comprising a first subset of nodes and a first subset of edges, based on the first set of features;
isolating a first set of candidate features defined in the bounded region of the assembly graph;
based on the assembly graph:
for each feature in the set of candidate features:
generating a correlation, in a set of correlations, between the candidate feature and the defect; and
assembling the set of correlations into a correlation matrix;
isolating a first subset of features, in the set of candidate features, exhibiting correlations, in the set of correlations, exceeding a threshold correlation;
generating a prediction of a root cause of the defect, the root cause specifying the first subset of features; and
serving the prediction of the root cause of the defect to an operator portal.
